(19) United States
(12) Patent Application Publication
(10) Pub. No.: US 2003/0200317 A1
(43) Pub. Date: Oct. 23, 2003

(54) Method and system for dynamically allocating bandwidth to a plurality of network elements

(75) Inventors: Reuven Zeitak, Rehovot (IL); Omri Gat, Kiryat Tivon (IL)

Correspondence Address: TESTA, HURWITZ & THIBEAULT, LLP, HIGH STREET TOWER, 125 HIGH STREET, BOSTON, MA, 02110, US

(73) Assignee: Native Networks Technologies LTD, Petah Tikva (IL)

(21) Appl. No.: 10/126,488

(22) Filed: Apr. 19, 2002

(51) Int. Cl. G06F 15/173

(52) U.S. Cl. 709/226

(57) ABSTRACT

The invention allocates a portion of the common bandwidth resource to each network element, and each network element distributes its allocated portion locally using a fair distribution algorithm. In accordance with the invention, each network element determines its “local satisfaction”. “Global fairness” is achieved when local satisfaction is balanced between all of the network elements. This balance can include situations where the satisfaction values of all of the network elements are equal. This balance can also include situations where the working priority class of each of the backlogged network elements is the same. In one embodiment, the invention dynamically allocates portions of the common bandwidth resource using a control algorithm that strives to keep the satisfaction values equal among the network elements.

### BACKGROUND

1. Field of Invention

The invention generally relates to bandwidth allocation, and, more particularly, to dynamically allocating network bandwidth to a plurality of network elements sharing that network bandwidth.

2. Description of Prior Art

A distributed network includes two or more network elements. Each network element services the transmission needs of its one or more queues of data to be transmitted through the network. In one known implementation, the network elements of the distributed network compete for a common bandwidth resource, for example, trunk bandwidth or gateway port bandwidth. At each network element, the network element bandwidth is allocated fairly using weighted fair queuing (“WFQ”) or a similar algorithm. However, since the network is distributed, it is impractical to implement WFQ or similar algorithms globally (e.g., network-wide) to all of the queues of all of the network elements.

### SUMMARY OF THE INVENTION

An object of the present invention is to achieve global fairness in the allocation of the common bandwidth resource. The invention allocates a portion of the common bandwidth resource to each network element, and each network element distributes its allocated portion locally using a fair distribution algorithm (e.g., a WFQ technique). In accordance with the invention, each network element determines its “local satisfaction” (i.e., the service it has been able to give its queues). “Global fairness” is achieved when local satisfaction is balanced between all of the network elements. This balance can include situations where the satisfaction values of all of the network elements are equal. This balance can also include situations where the working priority class (“WPC”) of each of the backlogged network elements is the same. In one embodiment, the invention dynamically allocates portions of the common bandwidth resource using a control algorithm that strives to keep the satisfaction values equal among the network elements. In another embodiment, the satisfaction values and bandwidth allocations are communicated within the distributed network using a special control packet, sometimes referred to as a resource management packet.

In one aspect the invention relates to a method to achieve global fairness in allocating a network bandwidth in a communications network having a plurality of network elements, each network element associated with one or more sources. The method comprises determining a satisfaction value for each of the network elements in response to a communication parameter, each of the network elements using the communication parameter to approximate virtual time for its respective one or more sources and determining an allocation of a portion of the network bandwidth for each of the network elements in response to a respective one of the satisfaction values. In one embodiment, the method further comprises determining a working priority class of each of the plurality of network elements.

In another embodiment, the method further comprises measuring the communications parameter in response to a working priority class. In another embodiment, the method further comprises receiving a collect messenger data packet, obtaining one or more of the satisfaction values from the received collect messenger data packet and transmitting an action messenger packet to each of the plurality of network elements, the action messenger packet indicating the respective allocation for each of the plurality of network elements. In another embodiment, the method further comprises transmitting a collect messenger data packet to each of a plurality of network elements. In another embodiment, the method further comprises modifying, at one of the plurality of network elements, the collect messenger data packet in response to a respective satisfaction value.

In another embodiment, the method steps of determining the satisfaction value, determining the allocation, obtaining and transmitting are all performed at only one of the network elements. In another embodiment, the method steps of determining the satisfaction value, determining the allocation, obtaining and transmitting are distributed over more than one of the network elements.

In another embodiment, the method further comprises determining a satisfaction value for a first network element in response to a parameter of a queuing algorithm used by the first network element on its one or more sources. In another embodiment, the method further comprises determining a number of round-robin rounds completed by the first network element in a predetermined time interval and employing the number of round-robin rounds in the predetermined time interval as the parameter.

In another embodiment, the method further comprises determining a proportion of time between a predefined time interval that the first network element is in an unstressed condition and employing the proportion of time in an unstressed condition as the parameter. In another embodiment, the method further comprises determining a satisfaction value for a second network element in response to a parameter of a queuing algorithm used by the second network element on its one or more sources, determining an allocation of a portion of the network bandwidth for the second network element in response to its respective satisfaction value and determining a first change to an allocation for the first network element in response to the satisfaction value for the first network element and the satisfaction value for the second network element.

In another embodiment, the method further comprises determining the global working priority class of the communications network, wherein the satisfaction value for the first network element and the satisfaction value for the second network element are in response to the global working priority class. In another embodiment, the method further comprises determining the first change such that the difference between a second satisfaction value of the first network element and a second satisfaction value of the second network element is less than a difference between the first satisfaction value of the first network element and the first satisfaction of the second network element.

In another embodiment, the first change to the allocation for the first network element is equal to a predetermined bandwidth value. In another embodiment, the method further comprises modifying the predetermined bandwidth value to control the rate at which a future satisfaction value of the first network element and a future satisfaction value of the second network element are made equal.

In another embodiment, the method further comprises determining a second change to the allocation for the first network element in response to a second satisfaction value for the first network element and a second satisfaction value for the second network element. In another embodiment, the method further comprises determining a magnitude of the second change to the first bandwidth allocation for the first network element in response to the polarity of the first and second changes to the allocation for the first network element. In another embodiment, the method further comprises determining a satisfaction value for a second network element in response to a parameter of a queuing algorithm used by the second network element on its one or more sources, determining a satisfaction value for a third network element in response to a parameter of a queuing algorithm used by the third network element on its one or more sources, determining an allocation of a portion of the network bandwidth for the second network element in response to the respective satisfaction values of the first network element, the second network element and the third network element and determining an allocation of a portion of the network bandwidth for the third network element in response to the respective satisfaction values of the first network element, the second network element and the third network element, wherein the determining an allocation of a portion of the network bandwidth for the first network element step comprises determining an allocation of a portion of the network bandwidth for the first network element in response to the respective satisfaction values of the first network element, the second network element and the third network element.

In another aspect, the invention relates to a system for allocating bandwidth in a communications network. The system comprises a first network element interactive with one or more sources and a second network element in communication with the first network element, the second network element being interactive with one or more sources and including an allocation module. The allocation module is configured to obtain a satisfaction value for the first network element in response to a parameter of a queuing algorithm used by the first network element on the one or more sources associated therewith, and to determine an allocation of a portion of the network bandwidth for the first network element in response to the satisfaction value. In one embodiment, the first network element of claim further comprises a satisfaction value generator module. In another embodiment, the second network element comprises a trigger clock. In another embodiment, the system further comprises a third network element including one or more sources.

In another aspect, the invention relates to a common point for allocating a network bandwidth in a communications network having a plurality of network elements, the common point comprising an allocation module configured (i) to receive data indicative of a satisfaction value from each of the network elements and (ii) to determine a portion of the network bandwidth for each of the network elements in response to its respective satisfaction value.

In another aspect, the invention relates to an article of manufacture having computer-readable program portion contained therein for allocating a network bandwidth in a communications network having a plurality of network elements. The article comprises a computer-readable program portion for determining a satisfaction value for a first network element in response to a parameter of a queuing algorithm used by the first network element on its one or more sources and a computer-readable program portion for determining an allocation of a portion of the network bandwidth for the first network element in response to the satisfaction value.

### BRIEF DESCRIPTION OF THE DRAWINGS

The above and further advantages of the invention may be better understood by referring to the following description taken in conjunction with the accompanying drawing, in which:

FIG. 1 is a block diagram of an illustrative embodiment of a system to dynamically allocate bandwidth to a plurality of network elements in accordance with the invention;

FIG. 2 is a block diagram of another illustrative embodiment of a system to dynamically allocate bandwidth to a plurality of network elements in accordance with the invention;

FIG. 3 is a graph of an illustrative embodiment of a process to achieve global fairness in accordance with the invention;

FIG. 4 is a block diagram of an illustrative embodiment of a system to dynamically allocate bandwidth to a plurality of network elements with different priority sources in accordance with the invention;

FIG. 5 is a graph of another illustrative embodiment of a process to achieve global fairness in a multi-class environment in accordance with the invention; and

FIG. 6 is a flow diagram of an illustrative embodiment of a process to dynamically allocate bandwidth to a plurality of network elements in accordance with the invention. Note that the first number in the reference numbers of the figures indicate the figure in which the reference number is introduced.

### DETAILED DESCRIPTION

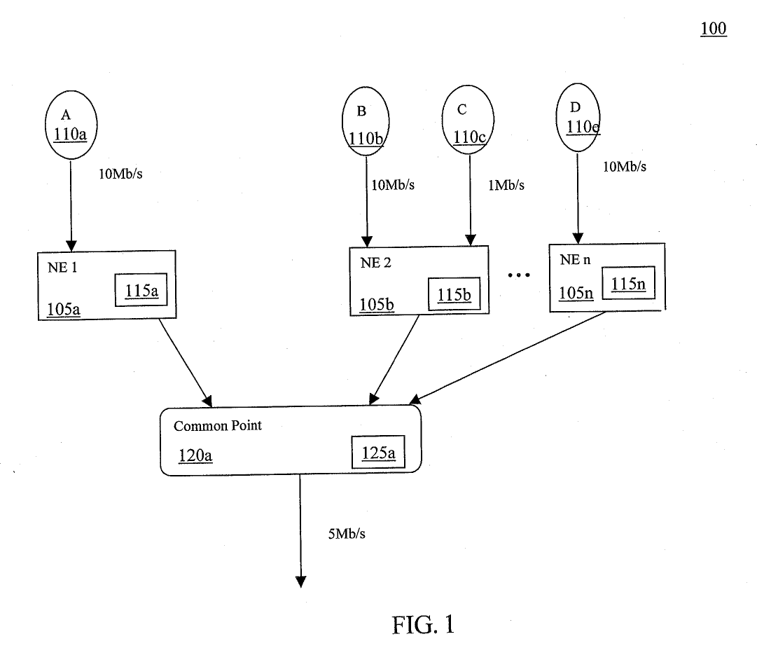

In broad overview, FIG. 1 illustrates a network 100 that includes a first network element 105a, a second network element 105b and an nth network element 105n, generally referred to as network elements 105. A network element 105 is a node in the network 100 that is responsible for transmitting data into a data stream within and/or through the network 100. A network element 105 can be, for example, a computing device, such as a router, a traffic policer, a switch, a packet add/drop multiplexer and the like. In different embodiments, the number of network elements 105 can vary from two to many. The inventive techniques described herein are not limited to a certain number of network elements 105. Each network element 105 is associated and/or interacts with one or more sources of data (e.g., queues), generally referred to as 110, that contain the data waiting to be transmitted through the network 100. A source 110 may also be part of and included within the network element 105. A source 110 generates data packets that need to be transmitted to a network element 105 across the network 100 via a common link. A source 110 can be, for example, a client device in communication with a network element 105 over a WAN, and/or a data server that delivers computer files in form of data packet streams in response to a data request. A source 110 can also be, for example, a digital video camera that transmits images in form of data packets, one of various telecommunication devices that relay telecommunication data and the like.

In the illustrated embodiment, the first network element 105a is associated and/or interacts with a first source 110a. The first network element 105a also includes a satisfaction value generator module 115a. Modules can be implemented as software code. Alternatively, modules can be implemented in hardware using, for example, FPGA and/or ASIC devices. Modules can also comprise processing elements and/or logic circuitry configured to execute software code and manipulate data structures. The satisfaction value generator module, generally 115, generates a satisfaction value for its respective network element 105 as described in more detail below. The second network element 105b is associated and/or interacts with a first source 110b and a second source 110c. The second network element 105b also includes a satisfaction value generator module 115b. The n^{th} network element 105n is associated and/or interacts with a first source 110e. The n^{th} network element 105n also includes a satisfaction value generator module 115n.

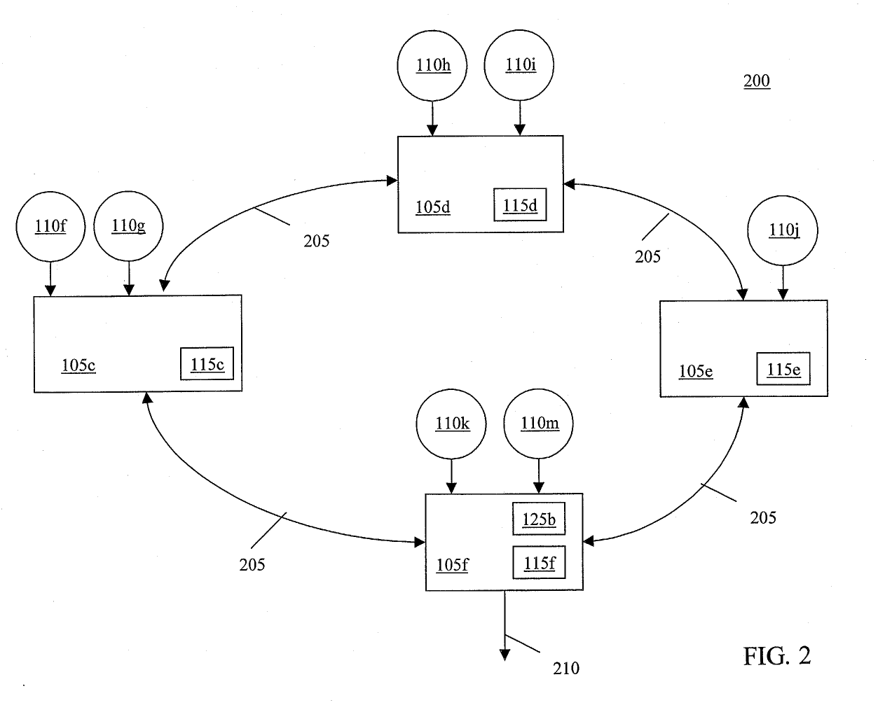

The network 100 also includes a common point network element 120a through which all of the transmitted data passes. Because all of the transmitted data passes through the common point 120a, also referred to as the common bandwidth resource and referred to generally as 120, the bandwidth of the common point 120a determines the network bandwidth. Each of the network elements 105 is in communication with the common point network element 120a. The common point 120a includes an allocation module 125a that allocates portions of the network bandwidth to each of the network elements 105. The common point 120a is distinguished from the other network elements 105 to highlight that a common point 120 is a point (e.g., trunk, gateway port, output port, bottleneck and the like) through which all of the transmitted data passes and which limits the flow of the data such that one or more sources 110 are backlogged. However, the common point 120 can also be considered and referred to as another network element 105 and can have its own sources 110 with which it is associated and/or interacts, as illustrated in FIG. 2.

In the illustrated embodiment of FIG. 1, the bandwidth of the common point 120a, and thus the network bandwidth, is 5 Mb/s. The allocation module 125a of the common point network element 120a allocates a portion of the network bandwidth to each of the network elements 105. The satisfaction value generator module 115 of each respective network element 105 calculates its respective local satisfaction value. As explained in more detail below, the satisfaction value generator module 115 generates its respective local satisfaction value based at least in part on a parameter that the respective network element 105 uses to achieve local fairness. For example, the parameter is the difference in virtual time between two measurements, normalized by the actual elapsed time if the network element 105 is using a WFQ algorithm to achieve local fairness. Each satisfaction value generator module 115 transmits its respective local satisfaction value to the allocation module 125a. In response to the local satisfaction values, the allocation module 125a allocates portions of the network bandwidth to each network element 105 to attempt to achieve global fairness. Global fairness is achieved when local satisfaction is balanced between all of the network elements 105. As local satisfaction values change over time, the allocation module 125a reallocates portions of the network bandwidth in response to those changes.

Local satisfaction represents the level of fair allocation of bandwidth on a local level. In other words, fair allocation of bandwidth resources of a single network element 105 is achieved by balancing the (weighted) service time given to all of the sources 110 (e.g., queues) backlogged at that network element 105. When the queues 110 are back logged, virtual time, a communication parameter that can be used to calculate/represent the local satisfaction value, is the amount of service each queue 110 receives if queues 110 are served in a weighted fair manner. Virtual time is undefined when no queues 110 are active, but if the offered rates of the queues 110 are limited, and the highest possible weight is also limited, the virtual time continues to increase during the idle period at a constant high rate, determined by the maximum arrival rate and the highest possible rate. For example, non-backlogged network elements 105 may be assigned satisfaction values larger than any possible satisfaction value for backlogged network elements 105, so that they do not obtain a portion of the network bandwidth.

In another embodiment, the communication parameter used to represent/calculate local satisfaction is the amount of time in a predefined time interval that there are no backlogged sources 110. For example, a network element 105 with no backlogged sources 110 within the predefined time interval has a local satisfaction value of 1. Similarly, a network element 105 that always services backlogged sources 110 during the predefined time interval has a local satisfaction value of 0, a network element 105 that services backlogged sources 110 for half of the predefined time interval has a local satisfaction value of 0.5 and other percentages are calculated similarly.

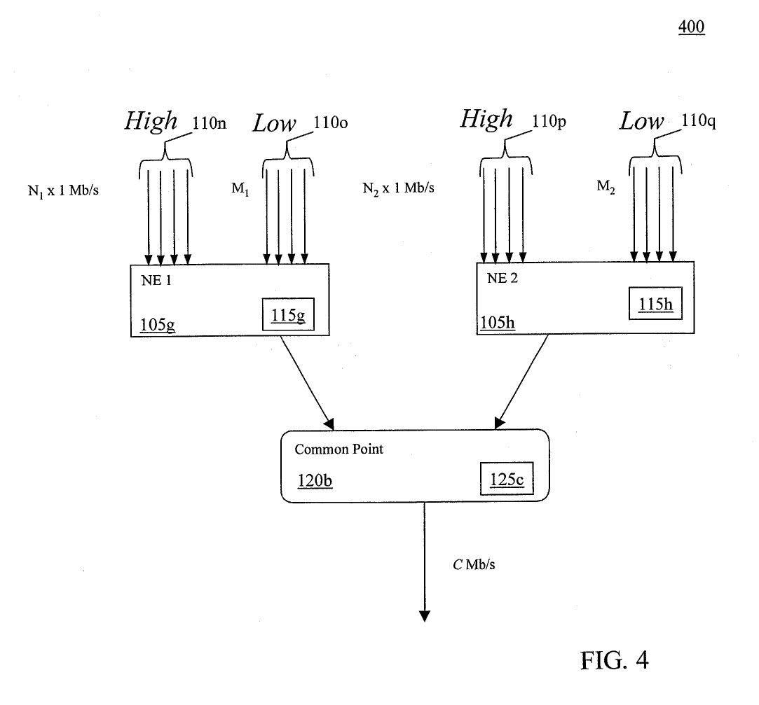

When the network element 105 serves prioritized traffic (e.g., as illustrated in FIG. 4), streams of a given priority class are not serviced as long there are backlogged queues 110 of higher priority. The network bandwidth is fairly allocated between all backlogged queues 110 in the same priority class. The WPC is the unique priority class that has serviced backlogged queues 110. In one embodiment, the WPC is not defined when the network element 105 is not backlogged.

The allocation module 125a may include a bandwidth reallocation algorithm in which the network 100 is likened to a control system, wherein the WPC and satisfaction of each network element 105 are controlled by the bandwidth allocated to it. The purpose of the reallocation algorithm is to achieve the following two conditions for global fairness: (1) The WPCs of all backlogged network elements 105 are the same, and (2) the satisfaction values of each of the network elements 105 are equal. The algorithm achieves this goal by allocating a larger portion of the network bandwidth to network elements 105 with high WPC and small satisfaction values, while reducing the portion of the network bandwidth allocated to the network elements with low WPC or high satisfaction values so as to keep the sum of the portions of the network bandwidth fixed or approximately fixed. Preferably working iteratively, the control algorithm reaches bandwidth allocations which, under static conditions, converge to the point of global fairness.

The fair allocation of a portion of the network bandwidth to a source 110 or a network element 105 depends both on the weight assigned to it, which may be viewed as static, and the instantaneous offered load on the link (i.e., the data being provided by the sources 110). Whenever either of these changes, the global fairness allocation values change as well, and the control algorithm follows these changing conditions, dynamically assigning a portion of the network bandwidth according to the instantaneous WPC and satisfaction. Hence, the reallocation control algorithm generates time-dependent network bandwidth allocations that continuously approximate global fairness in a changing environment.

FIG. 2 illustrates a synchronous optical network (“SONET”) ring 200. The network includes a first network element 105c, a second network element 105d, a third network element 105e and a fourth network element 105f. Connecting the network elements 105 in the topology of a ring, using an optical fiber 205, forms the network 200. The first network element 105c is associated and/or interacts with a first source 110f and a second source 110g. The first network element 105c also includes a satisfaction value generator module 115c. The first network element 105c is in communication with the second network element 105d and the fourth network element 105f, using the optical fiber 205. The second network element 105d is associated and/or interacts with a first source 110h and a second source 110i. The second network element 105d also includes a satisfaction value generator module 115d. The second network element 105d is in communication with the first network element 105c and the third network element 105e, using the optical fiber 205.

The third network element 105e is associated and/or interacts with a first source 110j. The third network element 105e also includes a satisfaction value generator module 115e. The third network element 105e is in communication with the second network element 105d and the fourth network element 105f, using the optical fiber 205. The fourth network element 105f is associated and/or interacts with a first source 110k and a second source 110m. The fourth network element 105f also includes a satisfaction value generator module 115f. The fourth network element 105f is in communication with the first network element 105c and the third network element 105e, using the optical fiber 205. The fourth network element 105f includes a single output port 210.

As illustrated, the fourth network element 105f is the common point in the SONET ring 200 because the bandwidth of the single output port is less than the needed bandwidth to service all of the sources 110 of the network 200. Thus the output port 210 of the fourth network element 105f is the bandwidth constraint for the network 200. Even though a common point, the fourth network element 105f includes the satisfaction value generator module 115f because it has its own sources 110k and 110m to consider in the allocation of the network bandwidth. The fourth network element 105f also includes an allocation module 125b. Though the allocation module 125b is located within the network element 105f that is the common point, this need not be the case. The allocation module 125 can be located in or associated with any network element 105 as long as the common point transmits the data indicating the value of the network bandwidth that the allocation module 125 can allocate to the network elements 105.

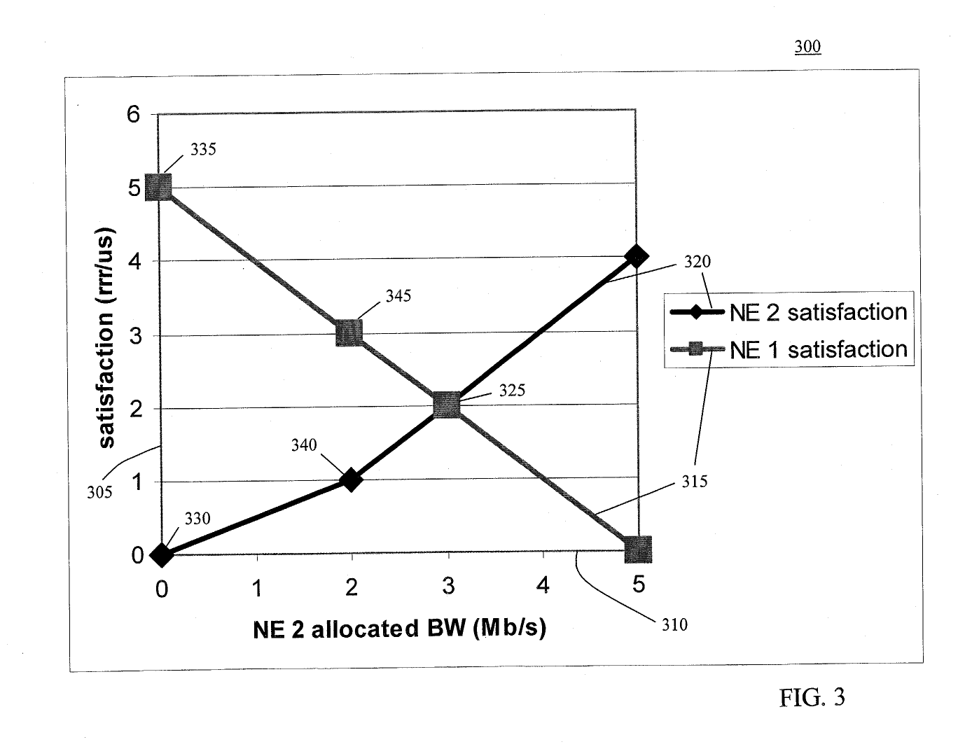

FIG. 3 illustrates a graph 300 of an embodiment of a process used by the allocation module 125a to achieve global fairness. For illustrative purposes and clarity, the parameters illustrated in FIG. 3 are taken with reference to a portion of the network 100 of FIG. 1 including the first network element 105a, the second network element 105b and the common point network element 120a. Of course, the principles illustrated can be used on more than two network elements 105. The value of the network bandwidth for this embodiment is the bandwidth value of the common point 120a, which is 5 Mb/s. In general overview, the y-axis 305 of the graph represents the local satisfaction values of the first network element 105a and the second network element 105b. The x-axis 310 of the graph 300 represents the portion of the network bandwidth (e.g., a portion of the 5 Mb/s) that the allocation module 125a allocates to the second network element 105b. The first line 315 plotted on the graph 300 is the local satisfaction value of the first network element 105a in response to the portion of the network bandwidth allocated to the first network element 105a. The second line 320 plotted on the graph 300 is the local satisfaction value of the second network element 105b in response to the portion of the network bandwidth allocated to the second network element 105b.

The allocation module 125a allocates portions of the network bandwidth to achieve global fairness, which in the illustrated embodiment is represented by point 325. At point 325, network elements 105a and 105b each have a local satisfaction value of 2 and thus there is global fairness. The portion of the network bandwidth the allocation module 125a allocates to the second network element 105b at point 325 to achieve global fairness is 3 Mb/s, as indicated by the x-axis 310. The portion of the network bandwidth the allocation module 125a allocates to the first network element 105a is the total network bandwidth of 5 Mb/s minus the value of the x-axis 310 (i.e., the portion of the network bandwidth allocated to the second network element 105b). Thus the portion of the network bandwidth the allocation module 125a allocates to the first network element 105a at point 325 to achieve global fairness is 2 Mb/s.

For example, in one embodiment, the allocation module 125a initially allocates 5 Mb/s to the first network element 105a and 0 Mb/s to the second network 105b, as indicated by points 330 and 335. With this allocation, the satisfaction value of the first network element 105a, as indicated by point 335, is 5. The satisfaction value of the second network element 105b, as indicated by point 330 is 0. Because of the large mismatch in local satisfaction values, the allocation module 125a reallocates the network bandwidth to attempt to make the local satisfaction values equal. In different embodiments, the change in the allocation of network bandwidth is based on a step size (i.e., a predetermined bandwidth value). In other embodiments, the step size changes, sometimes with each allocation. The change of step size can act as a rate control to prevent overshoot, for example, by making the step size smaller as the difference between the satisfaction values of the network elements 105 become smaller.

In general overview at points 330 and 335, with one satisfaction value at a maximum (i.e., 5) and the other satisfaction value at a minimum (i.e., 0), the allocation module 125a tries to split the difference in the allocation, in other words, 2.5 Mb/s to each of the network elements 105. Using a step size of an integer value, the allocation module 125a allocates 3 Mb/s to the first network element 105a and 2 Mb/s to the second network 105b, as indicated by points 345 and 340, respectively. With this allocation, the satisfaction value of the first network element 105a, as indicated by point 345, is 3. The satisfaction value of the second network element 105b, as indicated by point 340, is 1. Because of the mismatch in local satisfaction values, the allocation module 125a reallocates the network bandwidth to attempt to make the local satisfaction values equal. The allocation module 125a allocates 2 Mb/s to the first network element 105a and 3 Mb/s to the second network 105b, as indicated by point 325. With this allocation, the satisfaction value of the first network element 105a, as indicated by point 325, is 2. The satisfaction value of the second network element 105b, as indicated by point 325 is 2. Global fairness has been achieved and no further change in allocation is necessary, unless and until there is a change in the local satisfaction value of one or both network elements 105 and/or there is a change in the value of the network bandwidth.

In more detail, the satisfaction value illustrated on the y-axis 305 may be calculated using the parameter of round-robin rounds per microsecond. In other words, this value represents the parameter indicating, at the local level, the number of rounds a round-robin server, which serves a single bit at a time, completes in a predetermined time interval, in this case one microsecond. In this embodiment, all sources 110 are of equal weight. This condition implies that if all sources 110 are backlogged, each of them should be allocated 1/3 of the available network bandwidth, in other words 5/3 Mb/s. The second source 110c of network element 105b requests 1 Mb/s, which is less than its quota of 5/3 Mb/s, so the surplus should be evenly divided between sources 110a and 110b, which should receive 2 Mb/s each. Hence, in a globally fair allocation of the network bandwidth of 5 Mb/s, the allocation module 125 allocates 2 Mb/s to the first network element 105a and 3 Mb/s to the second network element 105b. The common satisfaction value in this case is 2 round-robin rounds per microsecond (rrr/μs), as indicated at point 325 of graph 300.

In one embodiment, the allocation module 125a initially allocates 4 Mb/s to the first network element 105a and 1 Mb/s to the second network element 105b. Following the plotted lines 315 and 320, with this allocation the satisfaction values of the first network element 105a and the second network element 105b are 4 rrr/μs and ½ rrr/μs respectively. The allocation module 125a transfers a portion of the network bandwidth from the first network element 105a to the second network element 105b. When the allocation module 125a shifts 1 Mb/s from the first network element 105a to the second network element 105b, indicated by points 340 and 345, this causes a slow increase in the local satisfaction because it serves both sources 110b and 110c. Following the plotted lines 315 and 320, with this allocation the satisfaction values of the first network element 105a and the second network element 105b are 3 rrr/μs and 1 rrr/μs, respectively. The change in satisfaction value for the second network element 105b only increases by ½ rrr/μs.

When the allocation module 125a shifts another 1 Mb/s from the first network element 105a to the second network element 105b, as indicated by point 325, this causes a faster rise in the satisfaction because the second source 110c in the second network element 105b is no longer backlogged. The satisfaction values are 2 rrr/μs and 2 rrr/μs for the first network element 105a to the second network element 105b respectively. The change in satisfaction value for the second network element 105b now increases by 1 rrr/μs. In one embodiment, the allocation module 125a dynamically changes the step size (i.e., the unit of transferred bandwidth) used in each iteration of allocating the network bandwidth to accommodate this change in the rate of change of the satisfaction value.

For example, in one embodiment, the allocation module 125a maintains a current step size in memory (not shown). At the beginning of each iteration the allocation module 125a sorts a list of the network elements 105 within the network 100, first in decreasing order of WPC, and then in increasing order of local satisfaction values. The allocation module 125a determines a pivot point in the list at the network element 105 that requires the smallest change in its bandwidth allocation to obtain the satisfaction value that approximates global fairness. The allocation module 125a increases the portion of the network bandwidth of all the network elements 105 whose position in the sorted list is before the pivot point by the absolute value of the stored step size. The allocation module 125a decreases the portion of the network bandwidth of all the network elements 105 whose position in the sorted list is after the pivot point by the absolute value of the stored step size. The allocation module 125a increases the step size by a predetermined growth factor if the sign (i.e., polarity, indicating whether bandwidth is added or taken away) of the current step size associated with a network element 105 is equal to the sign of the (stored) previous step size. The allocation module 125a decreases the step size by one half if the sign of the current step size of a network element 105 is opposite of the sign of the (stored) previous step size.

For example, referring to FIG. 3 and starting with points 340 and 345 on the graph 300, the first network element 105a has a portion of 3 Mb/s of the network bandwidth and the second network element 105b has a portion of 2 Mb/s of the network bandwidth. The stored step sizes are −1 Mb/s and +1 Mb/s respectively. In other words, the allocation module 125a previously had allocated 4 Mb/s to the first network element 105a and 1 Mb/s to the second network element 105b. The satisfaction value of the second network element 105b is 1 rrr/μs, which is smaller than the first network element 105a satisfaction value of 3 rrr/μs. In the next iteration, the allocation module increases the portion to the first network element 105a and decreases the portion of the second network element 105b. The allocation module 125a multiplies the step size by a growth factor of 3/2 because the signs of the step size have persisted (i.e., they are the same polarity as the stored values). The allocation module 125a thus determines the step size to be −1.5 Mb/s for the first network element 105a and +1.5 Mb/s for the second network element 105b. The allocation module 125a, using these new step sizes, allocates a portion of 1.5 Mb/s to the first network element 105a and a portion of 3.5 Mb/s to the second network element 105b.

With this allocation, the satisfaction value of the second network element 105b is now higher then the satisfaction value of the first network element 105a. In the next iteration, with the situation reversed, the allocation module 125a increases the portion allocated to the first network element 105a and decreases the portion to the second network element 105b. In this case, due to overshoot past the point of global fairness (i.e., 325), the signs of the step sizes are reversed. With the polarity reversed, the allocation module 125a decreases the absolute value of the step size, for example, by one-half. The step sizes become +0.75 Mb/s for the first network element 105a and −0.75 Mb/s for the second network element 105b. The allocation module 125a, using these new step sizes, allocates a portion of 2.25 Mb/s to the first network element 105a and a portion of 2.75 Mb/s to the second network element 105b. Again, there is overshoot, thus the polarities of the step sizes are reversed and the allocation module halves the step sizes. The allocation module 125a continues changing step sizes and reallocating in this fashion until the point of global fairness, as indicated by point 325, is gradually approached.

In many of the examples above, each of the sources 110 were considered to be of the same class and thus were treated equally. However, in other embodiments, the sources 110 include data of different priority, ranging from high priority data (e.g., voice communications), which cannot tolerate significant delays, to low priority data (e.g., electronic mail). FIG. 4 illustrates an embodiment of a network 400 that includes sources 110 of different priorities. The network 400 includes a first network element 105g and a second network element 105h. In different embodiments with a plurality of priority levels, the number of network elements 105 can vary from two to many. Though two network elements are described with the illustrated embodiment of FIG. 4, the inventive techniques described herein are not limited to a certain number of network elements 105. Each network element 105 is associated and/or interacts with one or more sources of data (e.g., queues), generally referred to as 110, that contain the data waiting to be transmitted through the network 400. The illustrated embodiment divides the sources 110 of each network element 105 into two groups; a group of high priority sources and a group of low priority sources. Other embodiments include three or more priority levels.

In the illustrated embodiment, the first network element 105g is associated and/or interacts with a first group of sources 110n that have a high priority level and a second group of sources 110o that have a low priority level. The first group of sources 110n has a number N1 of sources 110 with a high priority. The second group of sources 110o has a number M1 of sources 110 with a low priority. The first network element 105g also includes a satisfaction value generator module 115g. The second network element 105h is associated and/or interacts with a first group of sources 110p with a high priority level and a second group of sources 110q with a low priority level. The first group of sources 110p has a number N2 of sources 110 with a high priority. The second group of sources 110q has a number M2 of sources 110 with a low priority. The second network element 105h also includes a satisfaction value generator module 115h.

The network 400 also includes a common point network element 120b through which all of the transmitted data passes. Because all of the transmitted data passes through the common point 120b, the bandwidth of the common point 120b determines the network bandwidth. Each of the network elements 105g and 105h is in communication with the common point network element 120b. The common point 120b includes an allocation module 125c that allocates portions of the network bandwidth to each of the network elements 105g and 105h.

In the illustrated embodiment of FIG. 4, the bandwidth of the common point 120b, and thus the network bandwidth, is C Mb/s. The allocation module 125c of the common point network element 120b allocates a portion of the network bandwidth to each of the network elements 105. The satisfaction value generator module 115 of each respective network element 105 calculates its respective local satisfaction value. In response to the local satisfaction values, the allocation module 125c reallocates portions of the network bandwidth to each network element 105 to attempt to achieve global fairness. In the embodiment with a plurality of priority classes, global fairness is achieved when local satisfaction is balanced between all of the network elements 105 and the WPCs of all backlogged network elements 105 are the same.

In the illustrated embodiment, the first network element 105g services all sources 110n belonging to the high class before the sources 110o belonging to the low class. Likewise, the second network element 105h services all sources 110p belonging to the high class before the sources 110q belonging to the low class. For illustrative example, within each class (e.g., high priority or low priority), the network elements 105 service the sources 110 using a round-robin algorithm. Other servicing algorithms can be used. As indicated, each high priority source requires a bandwidth of 1 Mb/s to process all of the data within that source 110.

The first network element 105g therefore needs a bandwidth of N1 Mb/s to process all of its high priority sources 110n. If the allocation module 125c allocates less than N1 Mb/s to the first network element 105g, its WPC is high, since some or all of its high priority sources 110n are backlogged. If the allocation module 125c allocates N1 Mb/s or more to the first network element 105g, its WPC is low, since none of its high priority sources 110n are backlogged. Similarly, the second network element 105h needs a bandwidth of N2 Mb/s to process all of its high priority sources 110p. If the allocation module 125c allocates less than N2 Mb/s to the second network element 105p, its WPC is high, since some or all of its high priority sources 110p are backlogged. If the allocation module 125c allocates N2 Mb/s or more to the second network element 105h, its WPC is low, since none of its high priority sources 110p are backlogged. Thus, if both network elements 105g and 105h share a network bandwidth of less than N1+N2 Mb/s, the WPC of at least one of the network elements 105g or 105h is high.

Global fairness assesses satisfaction values of the same WPC, i.e., the global WPC. Global fairness thus dictates that the WPC of both network elements 105g and 105h be high (i.e., the global WPC is high), to prevent an unfair situation in which low priority sources 110 in one of the network elements 105 are serviced while high priority sources 110 in another network element 105 are backlogged. This unfair situation is not fair on a global basis because the allocation of the network bandwidth should ensure that all high priority sources 110 are serviced before bandwidth is allocated to low priority sources 110. Further, global fairness, using the round robin algorithm example, requires that the number of round-robin rounds each network element 105 performs per unit time (servicing the same WPC) is equal.

For an illustrative example, the network bandwidth is 60 Mb/s (i.e., C=60), the first network element 105g has 50 high priority sources 110n (i.e., N1=50) and the second network element 105h has 25 high priority sources 110p (i.e., N2=25). In this example, to achieve global fairness the allocation module 125c allocates a portion of less than 25 Mb/s to the second network element 105h to keep its WPC high. The allocation module 125c also allocates the remaining portion of the network bandwidth to the first network element 105g, keeping the allocation less than 50 Mb/s. This allocation keeps the WPC of both network elements 105g and 105h high, which is globally (i.e., network wide) fair.

Global fairness also means that the number of round-robin rounds each network element 105g and 105h performs per unit time (e.g., at the same WPC) is equal, implying that both network elements 105g and 105h receive portions of the network that are proportional to the number of sources 110 in that class (i.e., the number of sources 110 is used as the ratio because they are each at the same weight.). In other words, because one network element 105 has a higher proportion of high priority network sources 110, that network element 105 receives a higher proportion of the network bandwidth. Using the illustrative example above of C=60, N1=25 and N2=50, to achieve global fairness the allocation module 125c allocates a portion of20 Mb/s to the first network element 105g. The allocation module 125c allocates 40 Mb/s, the remaining portion of the network bandwidth, to the second network element 105h. The allocation module 125c eventually reaches this allocation because to keep the satisfaction values substantially equal, the ratio should be substantially 25:50 (i.e., in this case N1:N2). This allocation provides a satisfaction value of 20/25, or 0.8for the first network element 105g. This allocation also provides a satisfaction value of 40/50, or 0.8 for the second network element 105h. This allocation keeps the WPC of both network elements 105g and 105h high and splits the network bandwidth between the two network elements 105g and 105h in such a way as to keep the satisfaction value (e.g., round-robin rounds per unit time, or 0.8) of each substantially equal, which is globally fair.

If on the other hand the network bandwidth (i.e., C Mb/s) available to both network elements 105g and 105h is larger than N1+N2 Mb/s, for example (N1+N2+X) Mb/s, the WPC of both network elements 105g and 105h is low. In the case where X<2 min(M1, M2), each network element 105g and 105h receives bandwidth to service its low priority flows in a proportional manner (i.e., if all of the low queues have equal weights, the allocation ratio of the excess X Mb/s is split M1:M2). The total fair allocation is therefore N1+(X*M1/(M1+M2)) Mb/s to the first network element 105g and N2+(X*M2/(M1+M2)) Mb/s to the second network element 105h. For the case of the excess bandwidth (i.e., X Mb/s) being less than twice the smaller of M1 and M2, the allocation module 125 splits the excess proportionately because both network elements 105g and 105h still have backlogged low priority sources.

For an illustrative example, the network bandwidth is 60 Mb/s (i.e., C=60) and the first network element 105g has 20 high priority sources 110n (i.e., N1=20) and 10 low priority sources 110o (i.e., M1=10) at a load of 1 Mb/s each. The second network element 105h has 30 high priority sources 110p (i.e., N2=30) and 20 low priority sources 110q (i.e., M2=20) at a load of 1 Mb/s each. The allocation module 125 allocates 50 Mb/s, split 20 Mb/s to the first network element 105g and 30 Mb/s to the second network element 105h, to allow service of all of the high priority sources 110 and assess satisfaction at the low WPC. The allocation module 125 allocates the excess of 10 Mb/s proportionately between the first and second network elements 105g and 105h to achieve a substantially equal satisfaction value. In this numeric example, the ratio is 10:20. Thus, the allocation module 125c allocates 3.33 Mb/s of the 10 Mb/s excess to the first network element 105g. The allocation module 125c allocates 6.66 Mb/s of the 10 Mb/s excess to the second network element 105h. The satisfaction value of the first network element 105g is 3.33 Mb/s allocated divided by the 10 Mb/s needed, which is approximately 0.333. Similarly, the satisfaction value of the second network element 105h is 6.66 Mb/s allocated divided by the 20 Mb/s needed, which is also approximately 0.333.

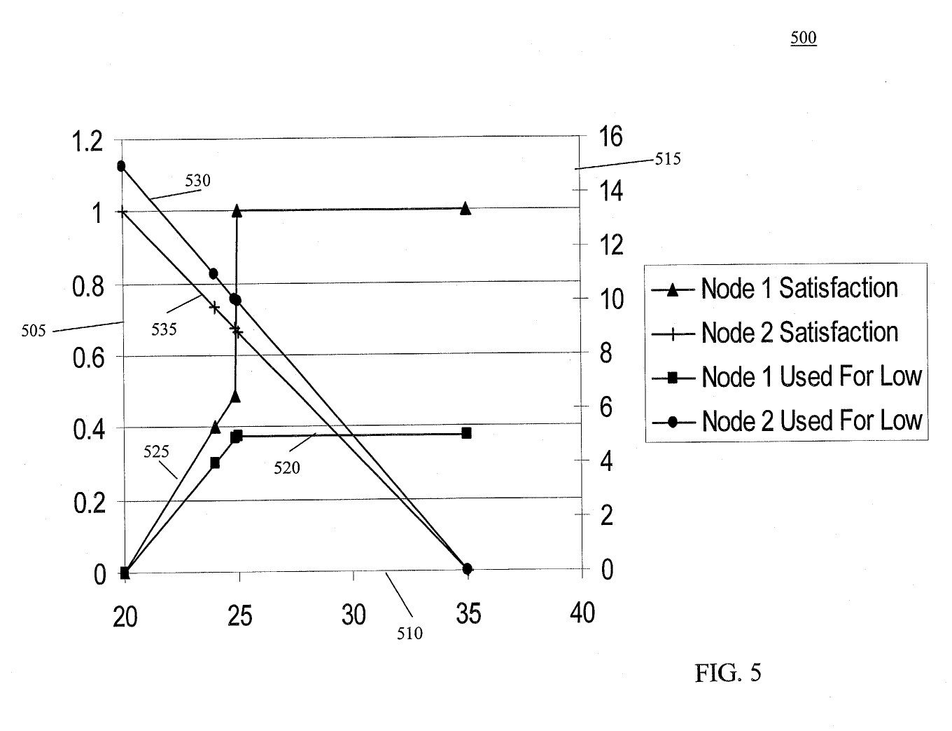

If one of the network elements 105 is able to service all of its low priority sources, then any remaining portion of excess above the proportional split is given to the other network elements 105. FIG. 5 illustrates a graph 500 of another embodiment of a process used by the allocation module 125a to achieve global fairness in a multi-class network. For illustrative purposes and clarity, the parameters illustrated in FIG. 5 are taken with reference to a portion of the network 400 of FIG. 4 including the first network element 105g, the second network element 105h and the common point network element 120b. Of course, the principles illustrated can be used on more than two network elements 105. The value of the network bandwidth for this graph 500 is 65 Mb/s (i.e., C=65 Mb/s).

In general overview, the left-hand y-axis 505 of the graph represents the local satisfaction values, measured in round-robin rounds per microsecond, of the first network element 105g and the second network element 105h. The x-axis 510 of the graph 300 represents the portion of the network bandwidth (e.g., a portion of the 65 Mb/s), measured in Mb/s, that the allocation module 125a allocates to the first network element 105g. This means that the amount allocated to the second network element 105h is 65 Mb/s minus the value of the x-axis 510. The right-hand y-axis 515 of the graph represents the amount of the allocated bandwidth, measured in Mb/s, used for the low sources 110o of the first network element 105g and the low sources 110q of the second network element 105h. The first line 520 plotted on the graph 500 is the amount of the allocated bandwidth to the first network element 105g used for the low sources 110o, as indicated on the right-hand y-axis 515. The second line 525 plotted on the graph 500 is the local satisfaction value of the first network element 105g in response to the portion of the network bandwidth used to satisfy the low sources 110o. The third line 530 plotted on the graph 500 is the amount of the allocated bandwidth to the second network element 105h used for the low sources 110q, as indicated on the right-hand y-axis 515. The fourth line 535 plotted on the graph 500 is the local satisfaction value of the second network element 105h in response to the portion of the network bandwidth used to satisfy the low sources 110q.

In this illustrative example, the first network element 105g has 20 high priority sources 110n (i.e., N1=20) and 10 low priority sources 110o (i.e., M1=10), but the low priority sources 110o are at a load of 0.5 Mb/s each. The second network element 105h has 30 high priority sources 110p (i.e., N2=30) and 15 low priority sources 110q (i.e., M2=15) at a load of 1 Mb/s each. The allocation module 125 allocates 50 Mb/s, split 20 Mb/s to the first network element 105g and 30 Mb/s to the second network element 105h, to allow service of all of the high priority sources and assess satisfaction at the low WPC. The allocation module 125 may initially allocate the excess of 15 Mb/s proportionately between the first and second network elements 105g and 105h using the 10:15 ratio (i.e., 6 Mb/s to the first network element 105g and 9 Mb/s to the second network element 105h). It is noteworthy that the ratio component for the first network element 105g uses 10, the number of sources 110o, even though the load is only half of the low priority sources 110q of the second network element 105h. This is because each queue has an equal weight in this embodiment. With this allocation, however, because the first network element 105g only needs 5 Mb/s to satisfy all of the low priority sources 110o, its local satisfaction value at the low WPC goes to the maximum value with an allocation of 6 Mb/s. The allocation module 125, after one or more iterations, allocates the excess 1 Mb/s that the first network element 105g does not need to the second network element 105h. In this example, the allocation module 125 eventually allocates 25 Mb/s to the first network element 105g and 40 Mb/s to the second network element 105h. With this eventual allocation, the satisfaction value for the first network element 105h is 1 because the network element 105g can service all of its queues 110n and 110o to meet their load conditions. The satisfaction value for the second network element 105h, at a low WPC, is 10/15, or 0.667. In this case, the satisfaction values are not identical. The satisfaction values are considered substantially equal, however, and global fairness is achieved. In this embodiment, as indicated at point 540 of graph 500, the point where the satisfaction values (e.g., lines 525 and 535) intersect is the point where they are considered substantially equal.

Referring back the FIG. 1, because the network 100 is a distributed network, the allocation module 125a and the satisfaction value generator modules 115 need to communicate data to each other, such as the WPC, the local satisfaction values and the portion of the network bandwidth allocated. In one embodiment, the network 100 uses a centralized processing approach, where one network element 105 is singled out as an active monitor and includes the allocation module 125 (e.g., the common point 120a). An internal clock triggers the allocation module 125 to periodically generate a resource management collect messenger data packet. The collect messenger data packet is a data packet that travels in turn to every network element 105 in the network 100 associated with the active monitor (e.g., the common point 120a). The network element 105 reports its local satisfaction values and its WPC by modifying predesignated fields in the collect messenger data packet. The collect packet arrives back at the allocation module 125 after having visited all the network elements 105, containing the WPC and satisfaction information for each network element 105. In one embodiment, if the collect messenger data packet does not return to the allocation module 125 within a predefined time-out period, the allocation module 125 indicates a failure.

Using the information contained in the arriving collect messenger data packet, the allocation module 125 performs the bandwidth reallocation control algorithm, using one of the many described algorithms above, and calculates new allocations of portions of the network bandwidth for each network element 105. The allocation module 125 transmits the new allocation to the other network elements 105 using a resource management action messenger packet. Upon receipt of the action messenger packet, the network elements 105 adjust their transmission rates accordingly. The allocation module 125 repeats this process. If the processing load in the active manager becomes too heavy, the allocation module 125 can use the action messenger packet to communicate intermediate values, which can be used by individual network elements 105 to calculate their allocations.

In other embodiments with networks larger than the illustrated network 100, the network uses a distributed processing approach to allocate the network bandwidth. In the distributed processing approach, individual network elements and/or a network element representative of a segment (i.e., portion) of the network generates the collect and action messenger packets. These network elements achieve fairness relative to their neighboring network elements, gradually approaching global fairness for the entire network.

In another embodiment, a network (not shown), with network elements 105 using an asynchronous packet transfer scheduler, uses the collect messenger and action messenger data packets. An asynchronous packet transfer scheduler schedules weighted best effort traffic as described in detail in copending U.S. patent application Ser. No. 09/572,194, commonly owned with the present application and hereby incorporated by reference. In general, using this scheduler, each user has an associated counter of the inverse leaky bucket type. Non-full buckets are incremented at rates that are proportional to the client's weight as specified in its service level agreement, and when a user's bucket becomes full the user is eligible to transmit a packet. Each time a packet is released from a given user's queue (i.e., source 110), this user's bucket is decremented by a number that is proportional to the released packet's size. If a situation is reached where there is a user who (a) has pending traffic and (b) has an eligible bucket, then all users' buckets stop filling. This is equivalent to defining a “stress function” that is 1 if the number of eligible-pending clients is zero and 0 otherwise. During periods where the leaky buckets are “frozen” as just described, the scheduler is in a stressed condition.

In this embodiment, the satisfaction value generator module 115 uses a communication parameter representing the proportion of time that the scheduler is in a non-stressed condition between the arrival of two resource management collect messenger data packets. The time during which the backlogged network elements 105 are unstressed is an approximation to the virtual time of WFQ and as such, the control algorithm of the allocation module 125 attempts to bring this value to be identical on all network elements 105. When the satisfaction values of backlogged schedulers is equal, the service given to a user is independent of the network element 105 to which the user belongs.

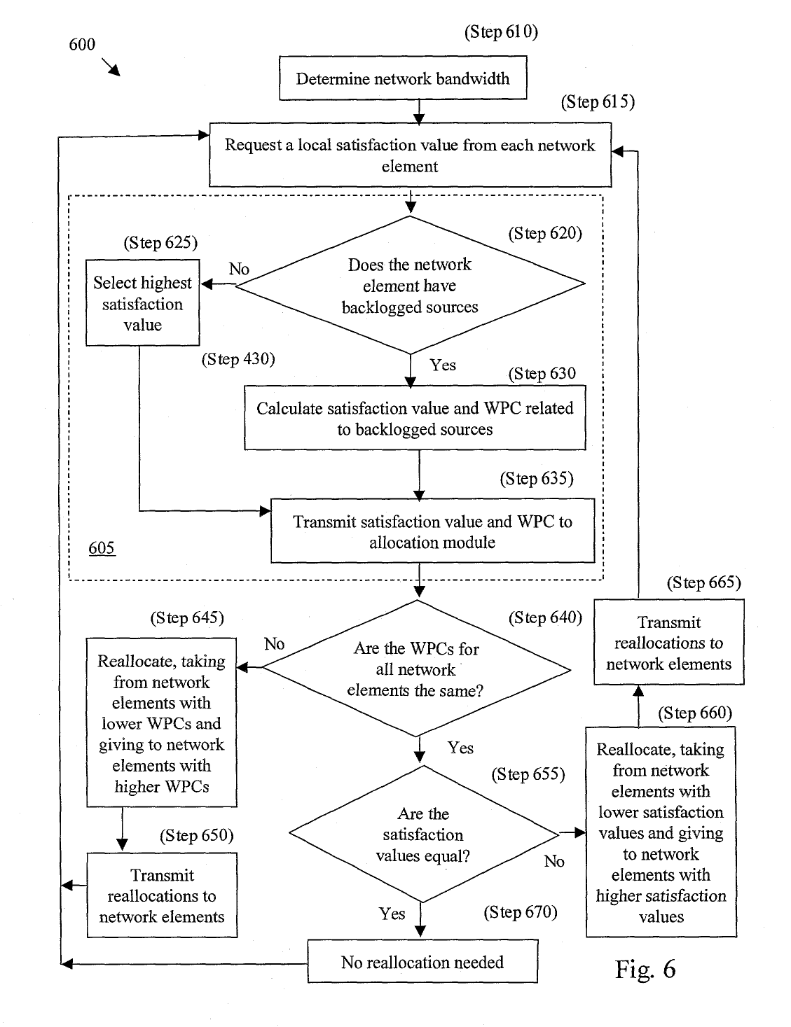

FIG. 6 illustrates a process 600 to dynamically allocate bandwidth to a plurality of network elements 105, for example, as depicted in FIG. 1, FIG. 2 and/or FIG. 4. In this embodiment, each satisfaction generator module 115 performs the steps within the dotted-line box 605 and the allocation module 125 performs the steps outside of the dotted-line box 605. The allocation module 125 determines (step 610) the network bandwidth that it apportions and allocates to the network elements 105. For example, if the fourth network element 105f of FIG. 2 is the common point, the allocation module 125b obtains from persistent storage (not shown) the value of the bandwidth of the output port 210 and uses that value as the network bandwidth. The allocation module 125 transmits (step 615) a request for a local satisfaction value to each network element 125. In response to this request, each network element 105 determines (steps 620, 625 and/or 630) its local satisfaction value. Each network element determines (step 620) whether any of its sources 110 is backlogged. If none of its sources 110 is backlogged, then that network element 105 has enough bandwidth and therefore the satisfaction value generator module 115 selects (step 625) the highest value allowable as the calculated satisfaction value.

If some or all of its sources 110 are backlogged, the satisfaction value generator module 115 of that network element 105 calculates (step 630) the WPC and satisfaction value based on the backlogged sources 110. For example, in the two class network 400, the satisfaction value generator module (e.g., 115g) calculates (step 630) a high WPC if any of the high level sources (e.g., 110n) are backlogged and a low WPC if none of the high level sources (e.g., 110n) are backlogged. The satisfaction value generator module 115g calculates (step 630) a local satisfaction value using one of the techniques as described above. For example, the satisfaction value can be based on the virtual time in a WFQ algorithm used by the network element 105. The satisfaction value can alternatively be based on another communication parameter, such as the number of round-robin rounds, the time in an unstressed condition, the time not servicing backlogged sources 110 and the like. In another embodiment, if the queues 110 are shaped/policed to conform to a given bandwidth policy, then the depth of the queues 110 can be used as a parameter for determining satisfaction. After the satisfaction value generator module 115 calculates (step 630) the WPC and the local satisfaction value for its respective network element 105, the satisfaction value generator module 115 transmits (step 635) that data to the allocation module 125.

When the allocation module receives the data from all of the network elements 105, the allocation module determines (step 640) if the WPCs for all of the network elements are the same. If the allocation module 125 determines (step 640) that all of the WPCs are not the same, the allocation module 125 dynamically reallocates (step 645) portions of the network bandwidth. As described in connection with FIG. 4, the allocation module 125 decreases (step 645) the portion of the network bandwidth allocated to a network element 105 with a low WPC and increases (step 645) the portion of the network bandwidth allocated to a network element 105 with a high WPC. The allocation module 125 transmits (step 650) this reallocation to the network elements 105. The allocation module 125, for example, after transmitting (step 650) the reallocation and/or after the expiration of a predefined time period, transmits (step 615) a request for a local satisfaction value to each network element 125.

If there is only one class of sources 110 in the network (e.g., 110a, 110b, 110c and 110d of FIG. 1), then by default, the WPCs of all of the network element 105 are the same. If the allocation module 125 determines (step 640) that all of the WPCs are the same, the allocation module 125 determines (step 655) if the satisfaction values of all of the network elements 105 are the same. If the allocation module 125 determines (step 655) that the satisfaction values of all of the network elements 105 are not the same, the allocation module 125 dynamically reallocates (step 660) portions of the network bandwidth. As described in connection with FIG. 3, the allocation module 125 decreases (step 660) the portion of the network bandwidth allocated to a network element 105 with a higher satisfaction value and increases (step 660) the portion of the network bandwidth allocated to a network element 105 with a lower satisfaction value. The allocation module 125 transmits (step 665) this reallocation to the network elements 105. The allocation module 125, for example, after transmitting (step 660) the reallocation and/or after the expiration of a predefined time period, transmits (step 615) a request for a local satisfaction value to each network element 125.

If the allocation module 125 determines (step 655) that the satisfaction values of all of the network elements 105 are the same, the allocation module 125 does not reallocate (step 670) portions of the network bandwidth. The allocation module 125, for example, after the expiration of a predefined time period, transmits (step 615) a request for a local satisfaction value to each network element 125. The steps of the process 600 are repeated to assess allocation of the network bandwidth to each of the network elements 105 and to reallocate network bandwidth if necessary to achieve and maintain global fairness.

Equivalents

The invention can be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. A method to achieve global fairness in allocating a network bandwidth in a communications network having a plurality of network elements, each network element associated with one or more sources, the method comprising:
determining a satisfaction value for each of the network elements in response to a communication parameter, each of the network elements using the communication parameter to approximate virtual time for its respective one or more sources; and
determining an allocation of a portion of the network bandwidth for each of the network elements in response to a respective one of the satisfaction values.

2. The method of claim 1 further comprising determining a working priority class of each of the plurality of network elements.

3. The method of claim 2 further comprising measuring the communications parameter in response to a working priority class.

4. The method of claim 1 further comprising:
receiving a collect messenger data packet;
obtaining one or more of the satisfaction values from the received collect messenger data packet; and
transmitting an action messenger packet to each of the plurality of network elements, the action messenger packet indicating the respective allocation for each of the plurality of network elements.

5. The method of claim 4 further comprising transmitting a collect messenger data packet to each of a plurality of network elements.

6. The method of claim 4 further comprising modifying, at one of the plurality of network elements, the collect messenger data packet in response to a respective satisfaction value.

7. The method of claim 4 wherein the steps of receiving, determining the satisfaction value, determining the allocation, obtaining and transmitting are all performed at only one of the network elements.

8. The method of claim 4 wherein the steps of receiving, determining the satisfaction value, determining the allocation, obtaining and transmitting are distributed over more than one of the network elements.

9. The method of claim 1 wherein the step of determining a satisfaction value comprises determining a satisfaction value for a first network element in response to a parameter of a queuing algorithm used by the first network element on its one or more sources.

10. The method of claim 9 wherein the step of determining the satisfaction value for the first network element comprises:
determining a number of round-robin rounds completed by the first network element in a predetermined time interval; and
employing the number of round-robin rounds in the predetermined time interval as the parameter.

11. The method of claim 9 wherein the step of determining the satisfaction value for the first network element comprises:
determining a proportion of time between a predefined time interval that the first network element is in an unstressed condition; and
employing the proportion of time in an unstressed condition as the parameter.

12. The method of claim 9 further comprising:
determining a satisfaction value for a second network element in response to a parameter of a queuing algorithm used by the second network element on its one or more sources;
determining an allocation of a portion of the network bandwidth for the second network element in response to its respective satisfaction value; and
determining a first change to an allocation for the first network element in response to the satisfaction value for the first network element and the satisfaction value for the second network element.

13. The method of claim 12 further comprising determining the global working priority class of the communications network, wherein the satisfaction value for the first network element and the satisfaction value for the second network element are in response to the global working priority class.

14. The method of claim 12 wherein the step of determining the first change further comprises determining the first change such that the difference between a second satisfaction value of the first network element and a second satisfaction value of the second network element is less than a difference between the first satisfaction value of the first network element and the first satisfaction of the second network element.

15. The method of claim 12 wherein the first change to the allocation for the first network element is equal to a predetermined bandwidth value.

16. The method of claim 15 further comprising modifying the predetermined bandwidth value to control the rate at which a future satisfaction value of the first network element and a future satisfaction value of the second network element are made equal.

17. The method of claim 12 further comprising determining a second change to the allocation for the first network element in response to a second satisfaction value for the first network element and a second satisfaction value for the second network element.

18. The method of claim 17 further comprising determining a magnitude of the second change to the first bandwidth allocation for the first network element in response to the polarity of the first and second changes to the allocation for the first network element.

19. The method of claim 9 further comprising:
determining a satisfaction value for a second network element in response to a parameter of a queuing algorithm used by the second network element on its one or more sources;
determining a satisfaction value for a third network element in response to a parameter of a queuing algorithm used by the third network element on its one or more sources;
determining an allocation of a portion of the network bandwidth for the second network element in response to the respective satisfaction values of the first network element, the second network element and the third network element; and
determining an allocation of a portion of the network bandwidth for the third network element in response to the respective satisfaction values of the first network element, the second network element and the third network element,
wherein the determining an allocation of a portion of the network bandwidth for the first network element step comprises determining an allocation of a portion of the network bandwidth for the first network element in response to the respective satisfaction values of the first network element, the second network element and the third network element.

20. A system for allocating bandwidth in a communications network comprising:
a first network element interactive with one or more sources; and
a second network element in communication with the first network element, the second network element being interactive with one or more sources and including an allocation module configured to obtain a satisfaction value for the first network element in response to a parameter of a queuing algorithm used by the first network element on the one or more sources associated therewith, and to determine an allocation of a portion of the network bandwidth for the first network element in response to the satisfaction value.

21. The first network element of claim 20 further comprising a satisfaction value generator module, the satisfaction value generator module determining the satisfaction value for the first network element.

22. The first network element of claim 20 further comprising a satisfaction value generator module, the satisfaction value generator module determining a number of round-robin rounds completed by the first network element in a predefined time interval and employing the number of round-robin rounds in the predefined time interval as the parameter.

23. The first network element of claim 20 further comprising a satisfaction value generator module, the satisfaction value generator module determining a proportion of time between a predefined time interval that the first network element is in an unstressed condition and employing the proportion of time in an unstressed condition as the parameter.

24. The system of claim 20 wherein the second network element is further configured to transmit a collect messenger data packet to the first network element and receive a modified collect messenger data packet transmitted by the first network element, the second network element generating an action messenger data packet in response thereto.

25. The system of claim 24 wherein the second network element comprises a trigger clock, the trigger clock initiating the transmitting of the collect messenger data packet to the first network element.

26. The system of claim 20 further comprising:
a third network element including one or more sources, and
wherein the second network element is further configured (i) to be in communication with the third network element, (ii) to obtain a satisfaction value for the third network element in response to a parameter of a queuing algorithm used by the third network element on its one or more sources, (iii) to determine an allocation of a portion of the network bandwidth for the first network element in response to the satisfaction values of the first network element, the second network element and the third network element, (iv) to determine an allocation of a portion of the network bandwidth for the second network element in response to the satisfaction values of the first network element, the second network element and the third network element and (v) to determine an allocation of a portion of the network bandwidth for the third network element in response to the satisfaction values of the first network element, the second network element and the third network element.

27. A common point for allocating a network bandwidth in a communications network having a plurality of network elements, the common point comprising an allocation module configured (i) to receive data indicative of a satisfaction value from each of the network elements and (ii) to determine a portion of the network bandwidth for each of the network elements in response to its respective satisfaction value.

28. The common point of claim 27 wherein the allocation module is further configured (i) to receive data indicative of a working class priority from each of the network elements and (ii) to determine a portion of the network bandwidth for each of the network elements in response to its respective satisfaction value and working class priority.

29. An article of manufacture having computer-readable program portion contained therein for allocating a network bandwidth in a communications network having a plurality of network elements, the article comprising:
a computer-readable program portion for determining a satisfaction value for a first network element in response to a parameter of a queuing algorithm used by the first network element on its one or more sources; and
a computer-readable program portion for determining an allocation of a portion of the network bandwidth for the first network element in response to the satisfaction value.
